(19) United States
(12) Patent Application Publication
(10) Pub. No.: US 2010/0235063 A1
(43) Pub. Date: Sep. 16, 2010

(54) VEHICLE CONTROLLER AND VEHICLE PROVIDED WITH THE CONTROLLER

(75) Inventors: Atsushi Kawamoto, Aichi-ken (JP); Masabumi Nishigaya, Aichi-ken (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: TOYOTA JIDOSHA KABUSHIKI KAISHA, AICHI-KEN (JP)

(21) Appl. No.: 12/599,828

(22) PCT Filed: Jan. 13, 2009
(86) PCT No.: PCT/JP09/50285

§ 371 Date: Nov. 12, 2009

(30) Foreign Application Priority Data
Jan. 21, 2008 (JP) 2008-010573

(51) Int. Cl. G06F 19/00

(52) U.S. Cl. 701/70; 701/99

(57) ABSTRACT

A hybrid vehicle (1) includes a rotation speed sensor (7) for detecting speed of rotation (Nm) of a motor generator (MG2). Fluctuation of the rotation speed (Nm) of the motor generator (MG2) reflects fluctuation of a first torque generated in a power transmitting member including a drive shaft (8). Hybrid vehicle (1) further includes a controller (30) for controlling a second torque transmitted from motor generator (MG2) through a rotation shaft of motor generator (MG2) to the power transmitting member, based on the speed of rotation (Nm) detected by rotation speed sensor (7). If the first torque is a vibration torque that fluctuates to cause the rotation shaft of motor generator (MG2) to rotate in positive and negative directions, controller (30) controls the second torque such that difference between absolute values of maximum value and minimum value of the vibration torque becomes smaller.

### TECHNICAL FIELD

The present invention relates to a vehicle controller and a vehicle provided with the controller and, more specifically, to a vehicle controller that prevents generation of excessive torque in the vehicle driving system, as well as to a vehicle provided with such a controller.

### BACKGROUND ART

Recently, vehicles such as hybrid vehicles, electric vehicles and fuel-cell vehicles having a motor mounted as a motive power source have attracting attention as environmentally friendly vehicles. By way of example, Japanese Patent Laying-Open No. 2002-78105 (Patent Document 1) discloses a hybrid vehicle having an engine and a motor as motive power sources. This reference discloses regenerative braking by the motor that takes place at the time of braking of the hybrid vehicle.

### Patent Document 1: Japanese Patent Laying-Open No. 2002-78105

### Patent Document 2: Japanese Patent Laying-Open No. 2007-126073

### DISCLOSURE OF THE INVENTION

### Problems to be Solved by the Invention

Japanese Patent Laying-Open No. 2002-78105 (Patent Document 1), however, does not specifically disclose a method of reducing torque generated in the driving system (for example, on a drive shaft) of the hybrid vehicle.

An object of the present invention is to provide a controller for a vehicle capable of preventing generation of excessive torque in the driving system, and to provide a vehicle provided with the same.

### Means for Solving the Problems

In short, the present invention provides a controller for a vehicle, including a motive power source having a rotation shaft, a driving wheel, and a power transmitting member coupled to the rotation shaft of the motive power source and to the driving wheel and capable of transmitting power from the power source to the driving wheel. The controller includes: a torque detecting unit for detecting a first torque generated in the power transmitting member; and a power control unit for controlling a second torque transmitted from the motive power source through the rotation shaft to the power transmitting member, based on the first torque detected by the torque detecting unit. The power control unit controls the second torque such that, when the first torque is a vibration torque fluctuating to cause the rotation shaft to rotate in positive and negative directions, difference between absolute values of a maximum value of the vibration torque and a minimum value of the vibration torque becomes smaller.

Preferably, the power control unit controls the second torque such that the difference becomes equal to zero.

Preferably, when the first torque is the vibration torque, the power control unit makes an absolute value of the second torque smaller than an absolute value of a torque transmitted to the power transmitting member immediately before generation of the vibration torque.

More preferably, the power control unit controls the second torque such that the absolute value of the second torque attains to zero.

More preferably, the motive power source is a rotating electric machine. The power control unit controls the second torque such that the rotating electric machine performs regenerative braking at the time of braking of the vehicle, and when generation of the vibration torque is detected at the time of braking of the vehicle, decreases the absolute value of the second torque by making smaller the regenerative energy generated by the regenerative braking.

Preferably, when the first torque is the vibration torque, the power control unit makes an absolute value of the second torque smaller than an absolute value of a torque transmitted to the power transmitting member immediately before generation of the vibration torque.

More preferably, the power control unit controls the second torque such that the absolute value of the second torque attains to zero.

More preferably, the motive power source is a rotating electric machine. The power control unit controls the second torque such that the rotating electric machine performs regenerative braking at the time of braking of the vehicle. When generation of the vibration torque is detected at the time of braking of the vehicle, the power control unit decreases the absolute value of the second torque by making smaller the regenerative energy generated by the regenerative braking.

According to another aspect, the present invention provides a vehicle, including: a motive power source having a rotation shaft, a driving wheel, a power transmitting member, a toque detecting unit, and a power control unit. The power transmitting member is coupled to the rotation shaft of the motive power source and to the driving wheel and capable of transmitting power from the motive power source to the driving wheel. The torque detecting unit detects a first torque generated in the power transmitting member. The power control unit controls a second torque transmitted from the power source through the rotation shaft to the power transmitting member, based on the first torque detected by the torque detecting unit. The power control unit controls the second torque such that, when the first torque is a vibration torque fluctuating to cause the rotation shaft to rotate in positive and negative directions, difference between absolute values of a maximum value of the vibration torque and a minimum value of the vibration torque becomes smaller.

Preferably, the power control unit controls the second torque such that the difference becomes equal to zero.

Preferably, when the first torque is the vibration torque, the power control unit makes an absolute value of the second torque smaller than an absolute value of a torque transmitted to the power transmitting member immediately before generation of the vibration torque.

More preferably, the power control unit controls the second torque such that the absolute value of the second torque attains to zero.

More preferably, the motive power source is a rotating electric machine. The power control unit controls the second torque such that the rotating electric machine performs regenerative braking at the time of braking of the vehicle. When generation of the vibration torque is detected at the time of braking of the vehicle, the power control unit decreases the absolute value of the second torque by making smaller the regenerative energy generated by the regenerative braking.

Preferably, when the first torque is the vibration torque, the power control unit makes an absolute value of the second torque smaller than an absolute value of a torque transmitted to the power transmitting member immediately before generation of the vibration torque.

More preferably, the power control unit controls the second torque such that the absolute value of the second torque attains to zero.

More preferably, the motive power source is a rotating electric machine. The power control unit controls the second torque such that the rotating electric machine performs regenerative braking at the time of braking of the vehicle. When generation of the vibration torque is detected at the time of braking of the vehicle, the power control unit decreases the absolute value of the second torque by making smaller the regenerative energy generated by the regenerative braking.

### EFFECTS OF THE INVENTION

According to the present invention, it becomes possible to prevent generation of excessive torque in the driving system.

### BRIEF DESCRIPTION OF THE DRAWINGS

FIG. 1 A block diagram showing a configuration of a hybrid vehicle 1 in accordance with an embodiment of the present invention.

FIG. 2 A circuit diagram showing, in detail, portions related to an inverter and an up-conversion unit of hybrid vehicle 1 of FIG. 1.

FIG. 3 A schematic diagram showing a portion related to the driving system of hybrid vehicle 1.

FIG. 4 An illustration showing hybrid vehicle 1 running on a rough road.

FIG. 5 A graph showing torque fluctuation in the driving system when hybrid vehicle 1 runs on the road shown in FIG. 4.

FIG. 6 A graph related to parameters used for controlling effective torque Te in accordance with an embodiment.

FIG. 7 A flowchart representing control of effective torque Te in accordance with an embodiment.

FIG. 8 A graph showing a change in rotation speed Nm of a motor generator MG2, when vibration torque generates in the driving system.

FIG. 9 A graph showing torque fluctuation in the driving system when effective torque Te is controlled in accordance with the embodiment.

### DESCRIPTION OF THE REFERENCE SIGNS

1 hybrid vehicle, 4, 6 gear, 5 brake pedal stroke sensor, 7, 27 rotation speed sensor, 8 drive shaft, 9 accelerator sensor, 10, 13, 21 voltage sensor, 11, 24U, 24V, 28U, 28V current sensor, 12 converter, 14, 14A inverter, 15, 15A U-phase arm, 16, 16A V-phase arm, 17, 17A W-phase arm, 20 up-conversion unit, 20L, 20R front wheel, 22R, 22L rear wheel, 25 driving wheel, 30 controller, 200 engine, B battery, B0-Bn battery unit, C1, C2 capacitor, D1-D8 diode, DG differential gear, L1 reactor, MG1, MG2 motor generator, N1, N2 node, PG planetary gear, Q1-Q8 IGBT element, SR1, SR2 system main relay.

### BEST MODES FOR CARRYING OUT THE INVENTION

In the following, embodiments of the present invention will be described in detail with reference to the figures. Throughout the figures, the same or corresponding portions are denoted by the same reference characters, and description thereof will not be repeated.

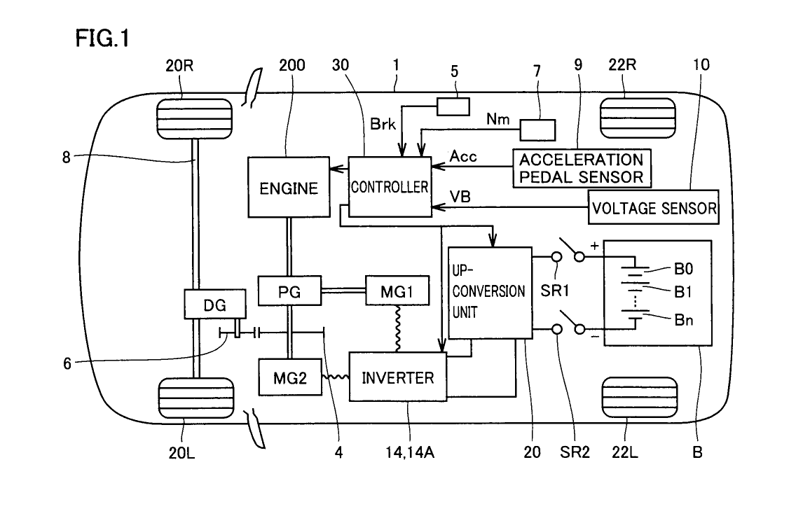

FIG. 1 schematically shows a configuration of a hybrid vehicle 1 in an embodiment of the present invention.

With reference to FIG. 1, hybrid vehicle 1 includes front wheels 20R and 20L, rear wheels 22R and 22L, an engine 200, a planetary gear PG, a differential gear DG, gears 4 and 6, and a drive shaft 8.

Hybrid vehicle 1 further includes a battery B, an up-conversion unit 20 up-converting voltage in a direct current (dc) power output from battery B, and inverters 14, 14A communicating the dc power with up-conversion unit 20.

Hybrid vehicle 1 further includes a motor generator MG1 receiving power of engine 200 via planetary gear PG to generate electrical power, and a motor generator MG2 having a rotation shaft connected to planetary gear PG. Inverters 14, 14A are connected to motor generators MG1 and MG2 to provide conversion between ac power and dc power provided from the up-conversion unit 20.

Planetary gear PG includes a sun gear, a ring gear, a pinion gear meshing with both the sun and ring gears, and a planetary carrier rotatably supporting the pinion gear around the sun gear. Planetary gear PG has first to third rotation shafts. The first rotation shaft is that of the planetary carrier, connected to engine 200. The second rotation shaft is that of the sun gear, connected to motor generator MG1. The third rotation shaft is that of the ring gear, connected to motor generator MG2.

The third rotation shaft has gear 4 attached thereto, which gear 4 drives gear 6 to transfer power to differential gear DG. Differential gear DG receives the power from gear 6 and transfers the power to front wheels 20R and 20L, and also transfers torque of front wheels 20R and 20L (torque of drive shaft 8) via gears 6 and 4 to the third rotation shaft of planetary gear PG.

Planetary gear PG, gears 4, 6, differential gear DG and drive shaft 8 are for transmitting power from the rotation shaft of motor generator MG2 to driving wheels (front wheels 20L, 20R), and shown in FIG. 1 as examples implementing the “power transmitting member” of the present invention.

Planetary gear PG serves to split power between engine 200 and motor generators MG1 and MG2. More specifically, when rotation of two rotation shafts of planetary gear PG is determined, the rotation of the remaining one rotation shaft will naturally be determined. Accordingly, engine 200 is operated in the most efficient range while the amount of power generated by motor generator MG1 is controlled, and motor generator MG2 is driven to control vehicle speed, to realize a generally energy-efficient vehicle.

Battery B as a dc power source is, for example, implemented by a nickel metal hydride, lithium ion, or similar secondary battery, and supplies dc power to up-conversion unit 20 and is also charged with dc power provided from up-conversion unit 20.

Up-conversion unit 20 up-converts dc voltage received from battery B and supplies the up-converted dc voltage to inverters 14, 14A. Inverters 14, 14A receive the supplied dc voltage and convert it to ac voltage, and control and drive motor generator MG1 when the engine is started. Furthermore, after the engine is started, ac power generated by motor generator MG1 is converted by inverters 14, 14A to a direct current and converted by up-conversion unit 20 to a voltage suitable for charging battery B, and thus battery B is charged.

Furthermore, inverters 14, 14A drive motor generator MG2. Motor generator MG2 assists engine 200 to drive front wheels 20R and 20L. In braking the vehicle, motor generator MG2 regeneratively operates to convert the rotation energy of the wheels to electrical energy. The obtained electrical energy is returned via inverters 14, 14A and up-conversion unit 20 to battery B.

Battery B is a set of batteries including a plurality of series-connected battery units B0-Bn. Between up-conversion unit 20 and battery B, system relays SR1, SR2 are provided to disconnect high voltage when the vehicle is not operated.

Hybrid vehicle 1 further includes an acceleration pedal position sensor 9 detecting the position of an accelerator pedal, which is an input portion receiving an instruction from a driver requesting acceleration, a brake pedal stroke sensor 5 detecting an amount of operation of the brake pedal by a driver, a voltage sensor 10 attached to battery B, and a controller 30 controlling engine 200, inverters 14, 14A, and up-conversion unit 20, in response to an accelerator pedal angle Acc received from acceleration pedal position sensor 9, a brake pedal operation amount Brk from brake pedal stroke sensor 5 and a voltage value VB received from voltage sensor 10. Voltage sensor 10 detects and transmits a voltage VB of battery B to controller 30.

Braking of hybrid vehicle 1 is realized by controller 30 controlling, in a coordinated manner, the regenerative braking force of motor generator MG2 and braking force of hydraulic brake (not shown). Therefore, at the time of braking of hybrid vehicle 1, controller 30 may operate only the hydraulic brake, not causing regenerative operation of motor generator MG2. Specifically, the regenerative braking force of motor generator MG2 is controllable by controller 30.

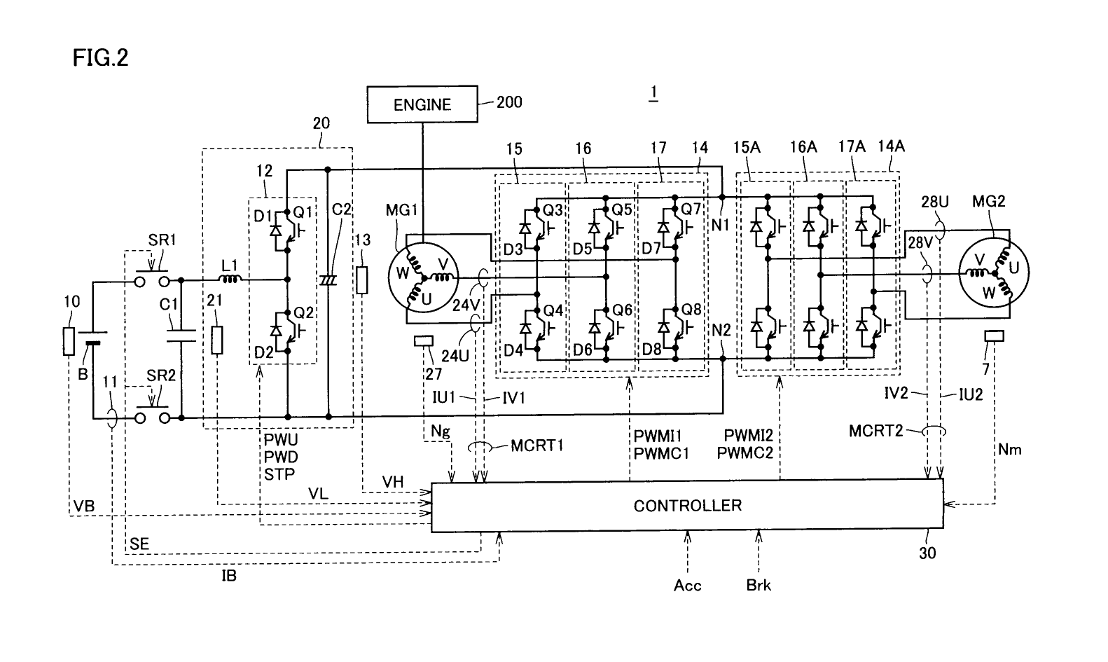

FIG. 2 is a circuit diagram specifically showing portions related to an inverter and an up-conversion unit of hybrid vehicle 1 of FIG. 1.

With reference to FIG. 2, hybrid vehicle 1 includes battery B, voltage sensor 10, system main relays SR1, SR2, capacitor C1, up-conversion unit 20, inverters 14, 14A, current sensors 24U, 24V, motor generators MG1, MG2, engine 200 and controller 30.

Motor generator MG1 mainly operates as an electric motor during running, and operates as a motor for cranking engine 200 during acceleration from the stopped state of the vehicle or from EV (Electric vehicle) running in which the vehicle runs with the engine stopped. Motor generator MG2 rotates in synchronization with front wheels 20R and 20L as driving wheels. Engine 200 and motor generators MG1 and MG2 are connected to planetary gear PG shown in FIG. 1. Therefore, when rotation speed of at least two rotation shafts among the rotation shafts of the engine and motor generators MG1 and MG2 are determined, the rotation speed of the remaining one rotation shaft is determined in a forced manner.

Battery B is a nickel metal hydride, lithium ion, or similar secondary battery. Voltage sensor 10 detects a dc voltage value VB output from battery B and outputs the detected dc voltage value VB to controller 30. System main relays SR1 and SR2 are turned on/off by a signal SE provided from controller 30. More specifically, system main relays SR1, SR2 are turned on by signal SE having H (logical high) level and turned off by signal SE having L (logical low) level. Capacitor C1 smoothes voltage between terminals of battery B when system main relays SR1, SR2 are turned on.

Up-conversion unit 20 includes a voltage sensor 21, a reactor L1, a converter 12, and a capacitor C2. Reactor L1 has one end connected via system main relay SR1 to a positive electrode of battery B.

Current sensor 11 detects a dc current flowing between battery B and up conversion unit 20 and outputs the detected current as a dc current value IB to controller 30.

Converter 12 includes IGBT (Insulated Gate Bipolar Transistor) devices Q1 and Q2 connected in series between output terminals of converter 12 outputting a voltage VH, and diodes D1 and D2 connected parallel to IGBT devices Q1 and Q2, respectively.

Reactor L1 has the other end connected to an emitter of IGBT device Q1 and to a collector of IGBT device Q2. Diode D1 has a cathode connected to a collector of IGBT device Q1, and an anode connected to the emitter of IGBT device Q1. Diode D2 has a cathode connected to the collector of IGBT device Q2, and an anode connected to an emitter of IGBT device Q2.

Voltage sensor 21 detects, as a voltage value VL, a voltage of converter 12 that is present at an input thereof. Current sensor 11 detects, as current value IB, a current flowing through reactor L1. Capacitor C2 is connected to an output side of converter 12 and stores energy sent from converter 12, and also smoothes voltage. Voltage sensor 13 detects the voltage on the output side of converter 12, that is, the voltage between electrodes of capacitor C2, as a voltage value VH.

In a hybrid vehicle 1, engine 200 and motor generator MG1 exchange mechanical power, and motor generator MG1 sometimes starts the operation of the engine and sometimes motor generator MG1 serves as a generator generating electrical power receiving the power from the engine. Motor generator MG1 is driven by inverter 14.

Inverter 14 receives an up-converted potential from converter 12 to drive motor generator MG1. Furthermore, inverter 14 returns to converter 12 the power generated by motor generator MG1. In doing so, converter 12 is controlled by controller 30 to operate as a down-conversion circuit.

Inverter 14 includes a U-phase arm 15, a V-phase arm 16, and a W-phase arm 17. U-phase arm 15, V-phase arm 16, and W-phase arm 17 are connected in parallel between output lines of converter 12.

U-phase arm 15 includes series connected IGBT devices Q3 and Q4, and diodes D3 and D4 connected parallel to IGBT devices Q3 and Q4, respectively. Diode D3 has a cathode connected to a collector of IGBT device Q3, and an anode connected to an emitter of IGBT device Q3. Diode D4 has a cathode connected to a collector of IGBT device Q4, and an anode connected to an emitter of IGBT device Q4.

V-phase arm 16 includes series connected IGBT devices Q5 and Q6, and diodes D5 and D6 connected parallel to IGBT devices Q5 and Q6, respectively. Diode D5 has a cathode connected to a collector of IGBT device Q5, and an anode connected to an emitter of IGBT device Q5. Diode D6 has a cathode connected to a collector of IGBT device Q6, and an anode connected to an emitter of IGBT device Q6.

W-phase arm 17 includes series connected IGBT devices Q7 and Q8, and diodes D7 and D8 connected parallel to IGBT devices Q7 and Q8, respectively. Diode D7 has a cathode connected to a collector of IGBT device Q7, and an anode connected to an emitter of IGBT device Q7. Diode D8 has a cathode connected to a collector of IGBT device Q8, and an anode connected to an emitter of IGBT device Q8.

Each phase arm has an intermediate point connected to a phase end of a phase coil of motor generator MG1. More specifically, motor generator MG1 is a 3-phase, permanent magnet motor with three, U, V and W phase coils each having one end connected to a neutral point. The U-phase coil has the other end connected to a node connecting IGBT devices Q3 and Q4 together. The V-phase coil has the other end connected to a node connecting IGBT devices Q5 and Q6 together. The W-phase coil has the other end connected to a node connecting IGBT devices Q7 and Q8 together.

Current sensors 24U and 24V detect current values IU1 and IV1 of the current flowing through the U-phase and V-phase stator coils of motor generator MG1 as motor current value MCRT1, and outputs the motor current value MCRT1 to controller 30. Rotation speed Ng of motor generator MG1 is detected by a rotation speed sensor 27.

Controller 30 receives a torque control value corresponding to motor generator MG1, rotation speed Ng of the motor, voltage values VB, VL and VH, current value IB, and motor current value MCRT1.

Inverter 14A is connected parallel to inverter 14 between nodes N1 and N2, and connected together with inverter 14 to up-conversion unit 20.

Inverter 14A receives an up-converted potential from converter 12 to drive motor generator MG2. Furthermore, inverter 14A returns to converter 12 the power generated by motor generator MG2 as the vehicle is regeneratively braked. In doing so, converter 12 is controlled by controller 30 to operate as a down-conversion circuit. Motor generator MG2 rotates at a rate Nm, which is detected by a rotation speed sensor 7.

Inverter 14A includes U, V and W phase arms 15A, 16A, and 17A, respectively, connected in parallel between output lines of converter 12. U, V and W phase arms 15A, 16A and 17A are similar in configuration to U, V and W phase arms 15, 16 and 17, respectively. Therefore, description thereof will not be repeated.

Intermediate points of the U, V and W phase arms of inverter 14A are respectively connected to one end of U, V and W phase coils of the motor generator MG2. More specifically, motor generator MG2 is a 3-phase, permanent magnet motor with three U, V and W phase coils each having the other end connected to a neutral point.

Current sensors 28U, 28V detect motor current values IU2 and IV2 flowing through the U-phase and V-phase stator coils of motor generator MG2 as motor current value MCRT2, and outputs motor current value MCRT2 to controller 30.

Controller 30 receives torque control value corresponding to motor generator MG1, the motor rotation speed Ng, voltage values VB, VL and VH, current value IB and motor current value MCRT1. Controller 30 further receives a torque control value corresponding to motor generator MG2, the motor rotation speed Nm of the motor and motor current value MCRT2. Controller 30 further receives accelerator pedal position Acc and brake pedal operation amount Brk.

In response to these inputs, controller 30 outputs to up-conversion unit 20 an instruction PWU to execute up-conversion, an instruction PWD to execute down-conversion, and an instruction STP to stop.

Furthermore, controller 30 outputs to inverter 14 an instruction PWMI1 to convert a dc voltage corresponding to an output of converter 12 to an ac voltage for driving motor generator MG1 and an instruction PWMC1 to convert ac voltage regenerated by motor generator MG1 to dc voltage and return the dc voltage to converter 12.

Furthermore, controller 30 outputs to inverter 14A an instruction PWMI2 to convert a dc voltage corresponding to an output of converter 12 to an ac voltage for driving motor generator MG2 and a regeneration instruction PWMC2 to convert ac voltage regenerated by motor generator MG2 to dc voltage and return the dc voltage to converter 12.

Regenerative braking includes braking with power regeneration that takes place when the driver driving the hybrid vehicle operates the foot brake. Further, regenerative braking includes deceleration or stopping acceleration of the vehicle while regenerating power, by releasing the accelerator pedal during running, without operating the foot brake.

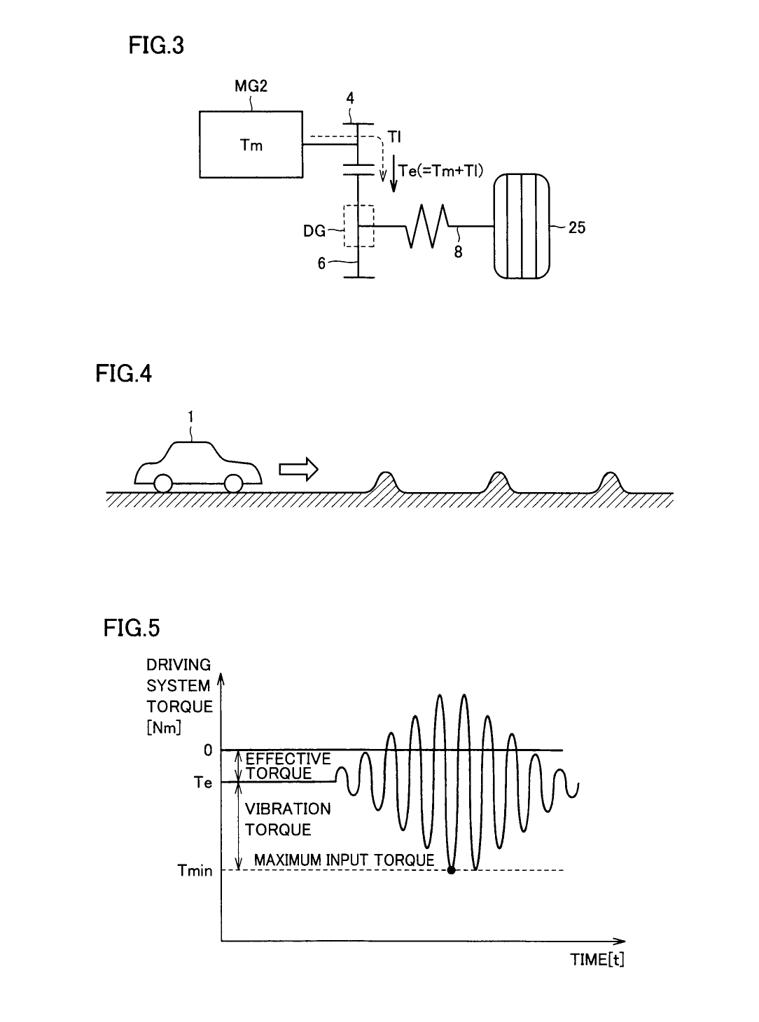

FIG. 3 is a schematic diagram showing a portion related to the driving system of hybrid vehicle 1. With reference to FIG. 3, driving wheel 25 generally represents front wheels 20R and 20L shown in FIG. 1. When motor generator MG2 and engine 200 drive hybrid vehicle 1, or when only motor generator MG2 drives hybrid vehicle 1, motor generator MG2 outputs torque. The torque drives gears 4 and 6, differential gear DG and drive shaft 8. Thus, driving wheel 25 rotates.

At the time of regenerative braking by motor generator MG2, the rotation force of driving wheel 25 is input through drive shaft 8, differential gear DG and gears 4 and 6 to motor generator MG2. Specifically, torque is input to motor generator MG2. Thus, motor generator MG2 generates electric power.

The torque generated at motor generator MG2 will be denoted as motor torque Tm, and the torque input to/output from motor generator MG2 will be denoted as effective torque Te. Effective torque Te is given by an expression Te=Tm+Tl Here, Tl represents force (torque) that prevents rotation of motor generator MG2, resulting, for example, from viscosity resistance of lubricant in motor generator MG2. In the following, this torque will be referred to as “drag torque Tl.” Drive shaft 8 has a function of a spring element.

Assume that hybrid vehicle 1 runs on a rough road. When sudden braking of the hybrid vehicle occurs and regenerative braking by the motor takes place, the torque input from the road surface to the drive shaft and the regenerative torque of motor may possibly be applied to the driving system including the drive shaft. In that case, a large torque may possibly generate in the driving system, though such a phenomenon has not been well known.

If the strength of driving system is to be increased in consideration of such a situation, components forming the driving system have to be made larger. This leads to increased weight of the driving system. Further, more expensive components may be required.

As shown in FIG. 4, if hybrid vehicle 1 runs on a rough road, a large torque may possibly generate on drive shaft 8. The plurality of projections on the road surface is assumed to exist at substantially the same interval. By way of example, when hybrid vehicle 1 runs on the road shown in FIG. 4, though its driving wheels vibrate upward/downward, vibration of the vehicle body would be reduced by a suspension. Further, when hybrid vehicle 1 runs on a projection, driving wheels will rotate idly and then the wheels will be in contact again, and such operations are expected to be repeated.

In such a situation, a torque of which intensity and direction change periodically generates in drive shaft 8. The torque causes, for example, torsional vibration in drive shaft 8. In the following, the torque of which intensity and direction change periodically will be also referred to as “vibration torque.”

It is expected that the driver brakes hard when hybrid vehicle 1 comes to such a road or during running on such a road. Here, as motor generator MG2 has high moment of inertia, a force that acts to stop rotation of drive shaft 8 (when the direction of rotation of drive shaft is considered in a positive direction, a torque in negative direction) increases. Further, the vibration torque mentioned above generates in drive shaft 8. As a result, large torque may possibly generate in drive shaft 8.

FIG. 5 shows torque fluctuation in the driving system when hybrid vehicle 1 runs on the road shown in FIG. 4. Referring to FIGS. 5 and 4, effective torque Te generates in the driving system (typically in drive shaft 8, though not limiting). This means that regenerative toque is input to motor generator MG2. As hybrid vehicle 1 runs on the road shown in FIG. 4, vibration torque also generates in the driving system, in addition to effective torque Te. Since the interval between projections on the road surface is substantially constant as shown in FIG. 4, vibration torque once increases and thereafter decreases.

If the vibration torque is positive, a torque that rotates the rotation shaft of motor generator MG2 in a first direction generates in a power transmitting member, and if the vibration torque is negative, a torque that rotates the rotation shaft of motor generator MG2 in a second direction opposite to the first direction generates in the power transmitting member. The first direction may be or may not be the same as the rotating direction of drive shaft.

Here, Tmin represents a torque having the largest absolute value. Torque Tmin is a sum of effective torque Te and the maximum value of vibration torque amplitude and, therefore it becomes a large torque. When the strength of driving system is to be increased in preparation for generation of torque Tmin, components forming the driving system will be larger and heavier. Further, use of more expensive components may become necessary.

It is noted that the positive maximum value of torque in the driving system and the negative maximum value of torque in the driving system (the largest of absolute values of negative values) are different. This results in the large value of Tmin. Therefore, the absolute value of torque Tmin can be made smaller if the absolute value of effective torque Te is made smaller than the value immediately preceding generation of the vibration torque and, the maximum value of torque input to the driving system can be made smaller.

Detailed description will be given. In the present embodiment, effective torque Te is controlled such that the difference between the positive maximum value of torque in the driving system and the maximum absolute value of negative value of torque in the driving system shown in FIG. 5 is made small. Here, by decreasing the absolute value of effective torque Te, the difference can be made smaller. Therefore, a state in which either the positive torque or negative torque is significantly large can be avoided. As a result, the maximum value of torque input to the driving system can be made small. If the torque input to the driving system increases, controller 30 decreases the absolute value of effective torque Te of motor generator MG2 at the time of regenerative braking, or sets the amount of regenerative energy to zero and thereby makes zero the value of effective torque.

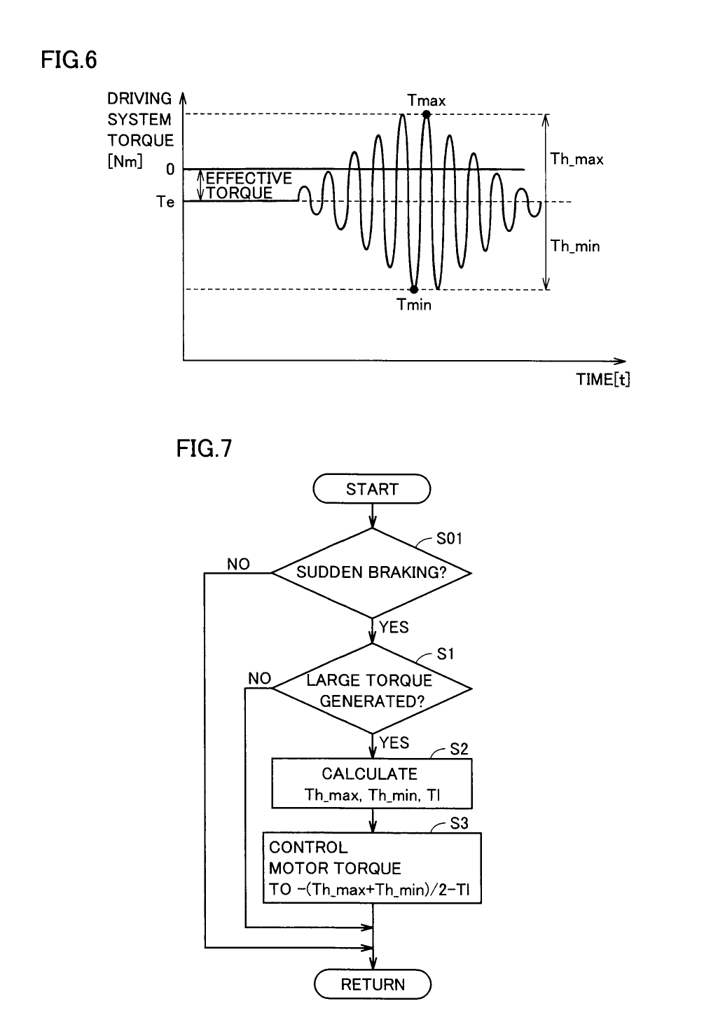

FIG. 6 shows parameters used for controlling effective torque Te in accordance with the present embodiment. Referring to FIG. 6, for controlling effective torque Te in accordance with the present embodiment, a positive side maximum fluctuation torque Th_max and a negative side maximum fluctuation torque Th_min are used. The maximum torque Tmax represents the positive maximum value of torque that generates in the driving system. The positive side maximum fluctuation torque Th_max represents a value from effective torque Te to maximum torque Tmax.

The minimum torque Tmin represents a negative value of torque that generates in the driving system, of which absolute value is the largest (it is noted that Tmin is a negative value). The negative side maximum fluctuation torque Th_min represents a value from effective torque Te to the minimum torque Tmin. It is noted that Th_min is a positive value.

FIG. 7 is a flowchart representing control of effective torque Te in accordance with the present embodiment. The process shown in the flowchart is called from the main routine and executed at every prescribed time interval or when prescribed conditions are satisfied.

Referring to FIGS. 7 and 2, when the process starts, at step S01, controller 30 determines whether sudden braking of hybrid vehicle 1 has occurred or not, based on the brake pedal operation amount Brk. If an amount of increase of brake pedal operation amount Brk per unit time (for example, one second) is larger than a prescribed threshold value, controller 30 determines that sudden braking has occurred. In that case (YES at step S01), the process proceeds to step S1. If controller 30 determines that sudden braking has not occurred (NO at step S01), the overall process returns to the main routine.

At step S1, controller 30 determines whether or not a large torque has been generated in the driving system. In the present embodiment, the determination at step S1 is made based on the speed of rotation Nm of motor generator MG2 detected by rotation speed sensor 7.

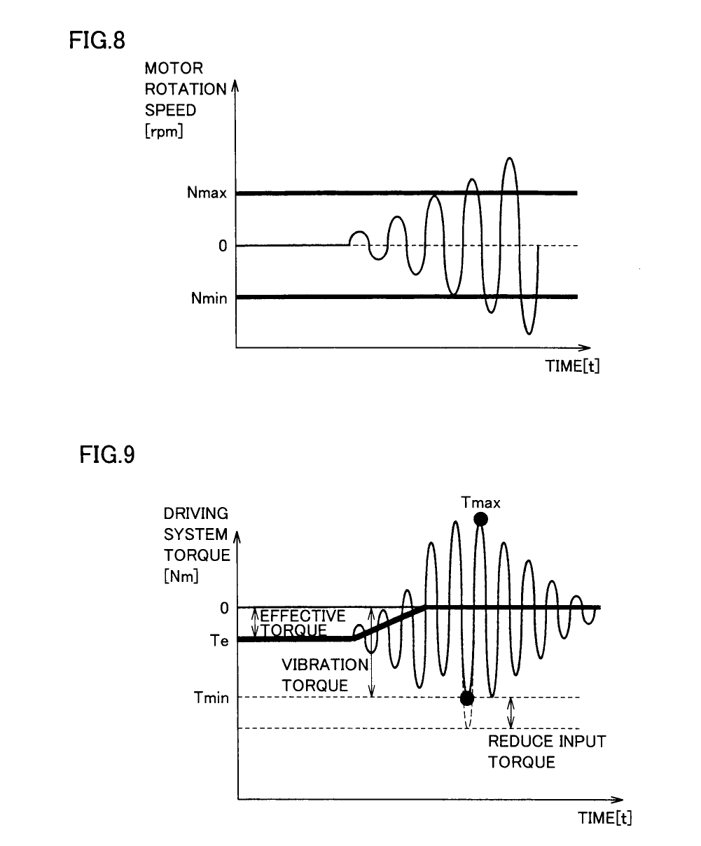

FIG. 8 shows a change in rotation speed Nm of motor generator MG2 when vibration torque generates in the driving system. Referring to FIG. 8, when the vibration torque generates in the driving system, the speed of rotation Nm (number of rotations of motor) of motor generator MG2 periodically fluctuates in the positive and negative directions. Further, the absolute value of speed of rotation increases with time.

If the speed of rotation Nm detected by rotation speed sensor 7 changes to be above a positive threshold value Nmax and below a negative threshold value Nmin, controller 30 determines that a large torque has generated in the driving system. Threshold values Nmax and Nmin are determined, for example, by an experiment, in advance. Controller 30 may determine that a large torque has generated in the driving system, if the speed of rotation Nm of motor generator MG2 is above the threshold value Nmax or if the speed of rotation Nm of motor generator MG2 is below the threshold value Nmin.

Again referring to FIGS. 7 and 2, if it is determined at step S1 that a large torque has generated in the driving system (YES at step S1), the process of step S2 is executed. At step S2, controller 30 calculates the positive side maximum fluctuation torque Th_max, negative side maximum fluctuation torque Th_min and drag torque TI.

By way of example, controller 30 stores in advance a map specifying correspondence between each of the positive side maximum fluctuation torque Th_max and the negative side maximum fluctuation torque Th_min and the speed of rotation Nm of motor generator MG2. The map represents information based on results of experiment, and is stored in controller 30. Using the speed of rotation Nm of motor generator MG2 received from rotation speed sensor 7 and the map, controller 30 calculates the positive side maximum fluctuation torque Th_max and the negative side maximum fluctuation torque Th_min.

Similar to the calculation of positive side maximum fluctuation torque Th_max (and negative side maximum fluctuation torque Th_min) described above, drag torque Tl may be calculated using the map specifying the relation between the speed of rotation Nm of motor generator MG 2 and drag torque Tl and the speed of rotation Nm detected by rotation speed sensor 7. The map represents information based on results of experiment, and is stored in controller 30. The drag torque TI may be a constant value.

At step S3, controller 30 controls motor torque Tm. Control of motor torque Tm realizes control of effective torque.

Motor torque Tm is calculated by inputting the positive side maximum fluctuation torque Th_max, the negative side maximum fluctuation torque Th_min and drag torque TI calculated at step S2, to Equation (1) below:

Tm=−(Th_max+Th_min)/2−Tl (1)

Controller 30 generates a regeneration instruction PWMC2 (or a drive instruction PWMI2) and outputs the generated regeneration instruction PWMC2 (or drive instruction PWMI2) to inverter 14A, so that the motor torque Tm as calculated in accordance with the equation generates in motor generator MG2.

When the process of step S3 ends, the overall process returns to the main routine. The overall process also returns to the main routine if it is determined at step S1 that a large torque has not generated in the driving system (NO at step S1).

FIG. 9 shows fluctuation of torque in the driving system, when effective torque Te is controlled in accordance with the present embodiment. Referring to FIGS. 8 and 9, when a large torque generates (YES at step S1), controller 30 calculates the positive side maximum fluctuation torque Th_max, the negative side maximum fluctuation torque Th_min and drag torque TI (step S2). Then, controller 30 inputs the calculated positive side maximum fluctuation torque Th_max, the negative side maximum fluctuation torque Th_min and drag torque Tl to predetermined Equation (1), to calculate motor torque Tm (step S3). Thereafter, controller 30 controls inverter 14A such that the calculated motor torque Tm generates in motor generator MG2.

Here, referring to FIG. 5, maximum torque Tmax is represented by the equation Tmax=Th_max+Te (Te is a negative value). Further, Te=Tm+Tl. Therefore, from Equation (1) and these equations, maximum torque Tmax can be given by Equation (2) below:

Tmax=Th_max−(Th_max+Th_min)/2=(Th_max−Th_min)/2 (2)

On the other hand, from FIG. 5, the minimum torque Tmin is represented by Tmin=−Th_min−Te.

From Equation (1) and the equation above, the minimum torque Tmin is represented by Equation (3) below:

Tmax=Th_min−(Th_max+Th_min)/2=−(Th_max−Th_min)/2 (3)

From Equations (2) and (3), the relation Tmax=−Tmin is derived. Specifically, the difference between the absolute values of maximum torque Tmax and minimum torque Tmin becomes zero. By controlling effective value Te in this manner at the time of sudden braking (the effective torque Te is made smaller than the absolute value of torque transmitted to the power transmitting member immediately before generation of vibration torque, whereby the regenerative energy is made smaller than usual or the regenerative energy is made zero), the maximum absolute value input to the driving system can be made smaller. When effective torque Te is adjusted to zero as described above, regenerative energy becomes zero.

As described above, according to the present embodiment, hybrid vehicle 1 includes a rotation speed sensor 7 that detects speed of rotation Nm of motor generator MG2. The fluctuation in speed of rotation Nm of motor generator MG2 detected by rotation speed sensor 7 reflects fluctuation of the first torque generated in the power transmitting member including drive shaft 8. Specifically, rotation speed sensor 7 functions as a torque detecting unit for detecting the first torque.

Hybrid vehicle 1 further includes controller 30 controlling a second torque (effective torque Te) transmitted from motor generator MG2 through the rotation shaft of motor generator MG2 to the power transmitting member, based on the speed of rotation Nm of motor generator MG2 detected by rotation speed sensor 7. If the first torque is vibration torque that fluctuates to cause the rotation shaft of motor generator MG2 to rotate in the positive and negative directions, controller 30 controls the second torque such that the difference between the absolute values of the maximum value and minimum value of the vibration torque is made smaller. The difference represents a state in which one of the absolute values of maximum torque Tmax and minimum torque Tmin is larger than the other. Therefore, if controller 30 controls the second torque so that the difference is made smaller, a state in which either the positive torque or negative torque is significantly larger than the other can be avoided. Thus, the maximum value of torque input to the driving system can be made smaller.

Here, as the effective torque Te is controlled such that the difference is made smaller, the state in which either the positive torque or the negative torque is significantly larger than the other can be avoided. It is noted, however, that controller 30 controls effective torque Te such that the difference attains to zero, as shown in FIGS. 8 and 9. This makes equal the absolute value of maximum torque Tmax and the absolute value of minimum torque Tmin and, therefore, the state in which either one of the positive and negative toques is larger than the other can more reliably be avoided.

(Modification)

In the present modification, the process of step S01 of the flowchart shown in FIG. 7 is omitted. Specifically, the process of step S1 is executed when the process operation starts. By such a process, effects shown in FIG. 9 can also be attained. Specifically, generation of excessive torque in the driving system can be avoided.

In the present embodiment, a series/parallel type hybrid system in which the engine power can be transmitted split by a power split device to the axle and the power generator has been described as an example. It is noted, however, that the present invention is also applicable to a series type hybrid vehicle in which the engine is used solely for driving the power generator and the axle driving force is generated only by the motor that uses the electric power generated by the generator, or to an electric vehicle which runs solely by the motor. These vehicles are all formed to have a motor connected to the axle, and at the time of deceleration, regenerative operation by the motor is possible. Therefore, the present invention is applicable.

Although the present invention has been described and illustrated in detail, it is clearly understood that the same is by way of illustration and example only and is not to be taken by way of limitation, the spirit and scope of the present invention being limited only by the terms of the appended claims.

1. A controller for a vehicle, including a motive power source (MG2) having a rotation shaft, a driving wheel (25), and a power transmitting member (8) coupled to said rotation shaft of said power source (MG2) and to said driving wheel (25) and capable of transmitting power from said motive power source (MG2) to said driving wheel (25), comprising:
a torque detecting unit (7) for detecting a first torque generated in said power transmitting member (8); and
a power control unit (30) for controlling a second torque transmitted from said motive power source (MG2) through said rotation shaft to said power transmitting member (8), based on said first torque detected by said torque detecting unit (7); wherein
said power control unit (30) controls said second torque such that, when said first torque is a vibration torque fluctuating to cause said rotation shaft to rotate in positive and negative directions, difference between absolute values of a maximum value of said vibration torque and a minimum value of said vibration torque becomes smaller.

2. The vehicle controller according to claim 1, wherein
said power control unit (30) controls said second torque such that said difference becomes equal to zero.

3. The vehicle controller according to claim 2, wherein
when said first torque is said vibration torque, said power control unit (30) makes an absolute value of said second torque smaller than an absolute value of a torque transmitted to said power transmitting member (8) immediately before generation of said vibration torque.

4. The vehicle controller according to claim 3, wherein
said power control unit (30) controls said second torque such that the absolute value of said second torque attains to zero.

5. The vehicle controller according to claim 3, wherein
said motive power source (MG2) is a rotating electric machine; and
said power control unit (30) controls said second torque such that said rotating electric machine performs regenerative braking at the time of braking of said vehicle, and when generation of said vibration torque is detected at the time of braking of said vehicle, decreases the absolute value of said second torque by making smaller the regenerative energy generated by said regenerative braking.

6. The vehicle controller according to claim 1 wherein
when said first torque is said vibration torque, said power control unit (30) makes an absolute value of said second torque smaller than an absolute value of a torque transmitted to said power transmitting member (8) immediately before generation of said vibration torque.

7. The vehicle controller according to claim 6 wherein
said power control unit (30) controls said second torque such that the absolute value of said second torque attains to zero.

8. The vehicle controller according to claim 6 wherein
said motive power source (MG2) is a rotating electric machine; and
said power control unit (30) controls said second torque such that said rotating electric machine performs regenerative braking at the time of braking of said vehicle, and when generation of said vibration torque is detected at the time of braking of said vehicle, decreases the absolute value of said second torque by making smaller the regenerative energy generated by said regenerative braking.

9. A vehicle, comprising:
a motive power source (MG2) having a rotation shaft;
a driving wheel (25);
a power transmitting member (8) coupled to said rotation shaft of said motive power source (MG2) and to said driving wheel (25) and capable of transmitting power from said motive power source (MG2) to said driving wheel (25);
a torque detecting unit (7) for detecting a first torque generated in said power transmitting member (8); and
a power control unit (30) for controlling a second torque transmitted from said motive power source (MG2) through said rotation shaft to said power transmitting member (8), based on said first torque detected by said torque detecting unit (7); wherein
said power control unit (30) controls said second torque such that, when said first torque is a vibration torque fluctuating to cause said rotation shaft to rotate in positive and negative directions, difference between absolute values of a maximum value of said vibration torque and a minimum value of said vibration torque becomes smaller.

10. The vehicle according to claim 9, wherein
said power control unit (30) controls said second torque such that said difference becomes equal to zero.

11. The vehicle according to claim 10, wherein
when said first torque is said vibration torque, said power control unit (30) makes an absolute value of said second torque smaller than an absolute value of a torque transmitted to said power transmitting member (8) immediately before generation of said vibration torque.

12. The vehicle according to claim 11, wherein
said power control unit (30) controls said second torque such that the absolute value of said second torque attains to zero.

13. The vehicle according to claim 11, wherein
said motive power source (MG2) is a rotating electric machine; and
said power control unit (30) controls said second torque such that said rotating electric machine performs regenerative braking at the time of braking of said vehicle, and when generation of said vibration torque is detected at the time of braking of said vehicle, decreases the absolute value of said second torque by making smaller the regenerative energy generated by said regenerative braking.

14. The vehicle according to claim 9, wherein
when said first torque is said vibration torque, said power control unit (30) makes an absolute value of said second torque smaller than an absolute value of a torque transmitted to said power transmitting member (8) immediately before generation of said vibration torque.

15. The vehicle according to claim 14, wherein
said power control unit (30) controls said second torque such that the absolute value of said second torque attains to zero.

16. The vehicle according to claim 14, wherein
said motive power source (MG2) is a rotating electric machine; and
said power control unit (30) controls said second torque such that said rotating electric machine performs regenerative braking at the time of braking of said vehicle, and when generation of said vibration torque is detected at the time of braking of said vehicle, decreases the absolute value of said second torque by making smaller the regenerative energy generated by said regenerative braking.
